(19) United States
(12) Patent Application Publication
(10) Pub. No.: US 2024/0383193 A1
(43) Pub. Date: Nov. 21, 2024

(54) EFFICIENT ADDITIVE MANUFACTURING

(71) Applicant: OPT Industries, Inc., Medford, MA (US)

(72) Inventors: Andre Schmeing, Somerville, MA (US); Mike Meichang Wang, New York, NY (US); Kai-Hong Anthony Chu, Cambridge, MA (US); Jifei Ou, Medford, MA (US)

(73) Assignee: OPT Industries, Inc., Medford, MA (US)

(21) Appl. No.: 18/667,163

(22) Filed: May 17, 2024

Related U.S. Application Data
(60) Provisional application No. 63/503,336, filed on May 19, 2023.

(51) Int. Cl. B29C 64/182; B29C 64/124; B29C 64/264; B29C 64/386; B33Y 10/00; B33Y 50/00

(52) U.S. Cl. CPC B29C 64/182; B29C 64/124; B29C 64/264; B29C 64/386; B33Y 10/00; B33Y 50/00

(57) ABSTRACT

Provided herein are systems and methods for efficiently printing 3D articles from a photo-curable resin. The systems and methods may iteratively execute a print file having instructions for printing the article, where a subsequent iteration may begin before a prior iteration has completed printing. In some embodiments, multiple iterations of an article may be printed onto a substrate as the substrate is moved into a vat of resin at an acute angle relative to the surface of the resin. Different portions of the multiple iterations of the article at respective intersection cut heights may be printed simultaneously within the same merged projection plane.

### NOTICE OF MATERIAL SUBJECT TO COPYRIGHT PROTECTION

Portions of the material in this patent document are subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### RELATED APPLICATIONS

This application claims priority to and the benefit under 35 USC 119 (e) of U.S. Provisional Application Ser. No. 63/503,336 filed May 19, 2023, entitled “EFFICIENT ADDITIVE MANUFACTURING,” the entire contents of which are incorporated herein by reference.

### BACKGROUND

Additive manufacturing technology, also known as 3D printing, allows for the manufacture of finished products with complex geometries that are difficult or impossible to make with other technologies. High-resolution stereolithography 3D printing, specifically Digital Light Processing (DLP) printing technology, can allow printing resolutions of less than 100 micrometers (um). High-resolution 3D printing allows one to produce intricate structures to reduce object weight, construct metamaterials, realize biomimicry design, or simply achieve aesthetic surface textures. Although the resolution of recent 3D printers has been improving, some applications can still be limited by inadequate computational methods.

### SUMMARY

Described herein are various techniques, including systems, computerized methods, and non-transitory computer readable media for 3D printing of a plurality of copies of an article. In some aspects, a method for continuous 3D printing of a plurality of copies of an article is provided that includes: executing a print file having instructions for printing a first copy of the article or first portion thereof on or adjacent to a first segment of a substrate; and subsequently executing the print file to print a second copy of the article or second portion thereof on or adjacent to a second segment of the substrate, wherein the second segment is adjacent to the first segment of the substrate.

In some embodiments, a system for continuous 3D printing of a plurality of copies of an article is provided that includes: a 3D printer having (i) a reservoir of photo-curable resin, (ii) a conveyor configured to convey a substrate through the reservoir of photo-curable resin, and (iii) a projector configured to project radiation at a surface of the photo-curable resin; and at least one processor configured to perform one or more operations. The one or more operations can comprise: executing a print file having instructions for printing a first copy of the article or first portion thereof on or adjacent to a first segment of a substrate; and subsequently executing the print file to print a second copy of the article or second portion thereof on or adjacent to a second segment of the substrate, wherein the second segment is adjacent to the first segment of the substrate.

In some embodiments, a non-transitory computer readable medium for 3D printing of a plurality of copies of an article comprises: one or more files each representing a respective article for printing and further containing first instructions for 3D printing the respective article; and second instructions for controlling a 3D printer to print a plurality of articles represented in the one or more files on a substrate at least partially simultaneously. The second instructions can comprise: a respective number of iterations for each of the plurality of articles to be printed on the substrate; and a gap distance between adjacent articles of the plurality of articles to be printed on the substrate.

In some embodiments, a 3D printed article comprises a plurality of copies of an article printed on a substrate, wherein: a first layer of a first copy of the article and a second layer of a second copy of the article extend in a projection plane and are printed simultaneously; and the substrate is moved into a reservoir of resin at an angle relative to a surface of the resin during printing, wherein the angle is an acute angle. The plurality of copies of the article are printed using one or more operations comprising: executing a print file having instructions for printing a first copy of the article or first portion thereof on or adjacent to a first segment of a substrate; and subsequently executing the print file to print a second copy of the article or second portion thereof on or adjacent to a second segment of the substrate, wherein the second segment is adjacent to the first segment of the substrate.

It should be appreciated that all combinations of the foregoing concepts and additional concepts discussed in greater detail below (provided such concepts are not mutually inconsistent) are contemplated as being part of the inventive subject matter disclosed herein. In particular, all combinations of subject matter within this disclosure are contemplated as being part of the inventive subject matter disclosed herein.

Still other aspects, examples, and advantages of these exemplary aspects and examples, are discussed in detail below. Moreover, it is to be understood that both the foregoing information and the following detailed description are merely illustrative examples of various aspects and examples, and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF DRAWINGS

Additional embodiments of the disclosure, as well as features and advantages thereof, will become more apparent by reference to the description herein taken in conjunction with the accompanying drawings. The components in the figures are not necessarily to scale.

FIG. 1 shows a schematic diagram of an example of a system for printing from the bottom-up through a transparent window.

FIG. 2 shows a schematic diagram of an example of a system for printing from the top-down.

FIG. 3 shows a schematic diagram of an example of a system for printing on a pliable substrate, in accordance with some embodiments of the present disclosure.

FIG. 4 shows a schematic diagram of an example of continuously stacked iterations, in accordance with some embodiments of the present disclosure.

FIG. 5 shows a schematic diagram of an example of a side view of iteration intersection cuts, in accordance with some embodiments of the present disclosure.

FIG. 6 shows a schematic diagram of an example of a top view of iteration intersection cuts, in accordance with some embodiments of the present disclosure.

FIG. 7 shows a schematic diagram of an example of merging stacked iteration projections, in accordance with some embodiments of the present disclosure.

FIG. 8 shows schematic diagrams of an example of a single iteration bounding box and projection length, in accordance with some embodiments of the present disclosure.

FIG. 9 shows a schematic diagram of an example of a single iteration bounding box and projection length, in accordance with some embodiments of the present disclosure.

FIG. 10 is a schematic diagram showing the geometric descriptors of iteration stacking, in accordance with some embodiments of the present disclosure.

FIG. 11 shows a schematic diagram of an example of an intersection cut of stacked iteration volumes, in accordance with some embodiments of the present disclosure.

FIG. 12A shows a table which represents an example of an implementation of iteration stacking in accordance with some embodiments of the present disclosure.

FIG. 12B shows a flow diagram of an example process for iteration stacking in accordance with some embodiments of the present disclosure.

FIG. 13 shows a schematic diagram of an example of stacked iterations having an alternating periodical pattern, in accordance with some embodiments of the present disclosure.

FIG. 14 shows a schematic diagram of an example of stacked iterations having a starting and ending file, in accordance with some embodiments of the present disclosure.

FIG. 15 shows a schematic diagram of an example of a printing system, in accordance with some embodiments of the present disclosure.

### DETAILED DESCRIPTION

Materials for the additive manufacturing industry, commonly referred to as 3D printing, may utilize a multitude of polymerization techniques to create 3D articles with desirable material performance properties for end-use applications.

The methods described herein may be used with any 3D printing system. The photo-curable resin may be any suitable resin that is capable of polymerization when exposed to radiation (e.g., ultraviolet (UV) radiation). The resin may be part of a formulation that may include a photo-initiator, a UV absorber, a pigment, a diluent, and one or more monomers or oligomers. In some cases, UV radiation interacts with the photo-initiator to start a free-radical mediated polymerization of the monomers and/or oligomers.

Traditionally, UV curable formulations used for additive manufacturing may include ethylenically (e.g., double bond) unsaturated oligomers and monomers (e.g., acrylates, methacrylates, vinyl ethers), diluents, photo-initiators, and additives. The oligomers and monomers may provide mechanical properties to the final product upon polymerization. Diluents may reduce overall formulation viscosity for ease of processing and handling. Diluents may be reactive and may be incorporated into the polymer matrix of the finished article. Photo-initiators may form free radicals upon exposure to actinic radiation (e.g., through photolytic degradation of the photo-initiator molecule). The free radicals may then utilize the ethylenically unsaturated chemical groups to form vinyl-based polymers. Additives may include but are not limited to pigments, dyes, UV absorbers, hindered amine light stabilizers, and fillers. Additives may be used to impart useful properties such as color, shelf stability, improved lifetime performance, higher UV stability, etc.

Following polymerization, the printed article may be removed from the vat of photo-curable resin and washed of residual (non-polymerized) resin. Further processing steps may include additional curing of the printed resin or performing a secondary polymerization.

It can be efficient to print a large number of copies of an article continuously or in a single production batch, for example, on the surface of a pliable substrate as described in U.S. patent application Ser. No. 17/668,503, which is incorporated herein by reference in its entirety. Existing approaches in printing a larger number of copies may include creating an executable file containing the slice pattern for one (or few) copies of the article, and repeating the execution of that file to print the batch, which is inefficient. In this approach, one iteration may need to finish printing before the next can begin, resulting in gaps of space and time. Existing approaches may include creating a single executable file containing the instructions for printing all of the articles (e.g., as a series of planar slices), which may lead to efficient use of space and materials on the 3D printer but can result in significant computational time and resources being needed. In instances where an executable file was created for a whole batch of efficiently printed articles, the file was large but contained repeated portions therein.

Accordingly, the inventors have developed techniques for 3D printing a plurality of continuous batches of articles that execute multiple files or multiple instances of a file within a single projection/execution layer, enabling at least partially simultaneous printing of multiple iterations of a same or different articles. In some embodiments, executing a file (e.g., a print file) for printing may include printing the file such as manufacturing the digital file loaded through the printing process. The process may include any aspect of the printing, such as computational processing, loading the voxel data, projecting the slices on the resin surface, moving the substrate (e.g., via a conveyor) etc. In some embodiments, a file may be created that when printed iteratively, results in a plurality of printed articles, despite the file not exclusively containing printing instructions for whole printed articles. As a result, the systems and methods described herein may achieve computational efficiency, material efficiency, and time efficiency for printing of continuous batches of articles.

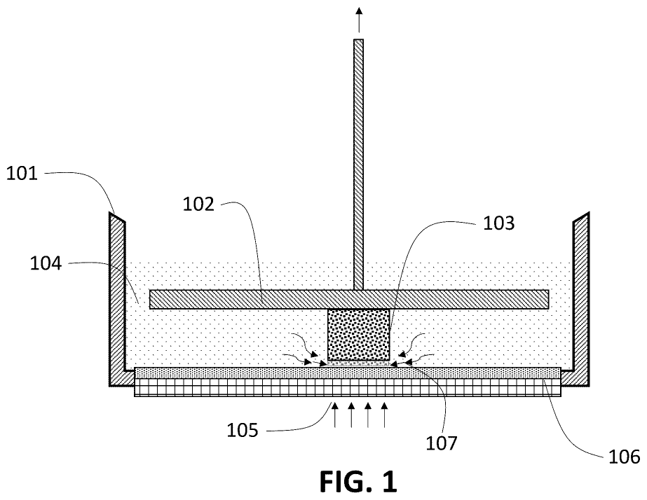

The methods described herein may be performed with any suitable 3D printing hardware (e.g., having digital light processors). FIGS. 1-3 show suitable systems for 3D printing. As seen in FIG. 1, printing can be performed from the bottom-up through a transparent window. Here, a container 101 can include a volume of photo-curable resin 104. UV light 105 can be projected through a glass plate or lens 106 onto a building platform 102. This can initiate polymerization into a cured article 103. The building platform can be moved upward, which can cause non-cured resin to flow and recoat 107 the printed article with resin such that a subsequent layer of the article can be printed.

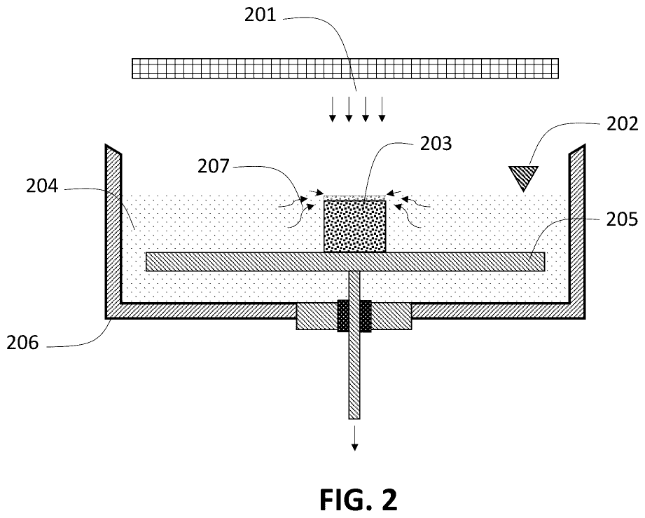

Similarly, FIG. 2 shows an example of a system for printing from the top-down. UV light 201 can be projected from the top-down onto an open surface of photocurable resin 204 that is contained in a vat 206. The cured article 203 can be printed onto a building platform 205 which can be moved downward into the vat of resin after each print layer. This can result in un-cured resin 207 flowing onto the surface of the cured article, which can be subsequently exposed to radiation to print another layer of the printed article. In some instances, this re-flow of resin is a rate limiting step of the overall process. Therefore, a recoating mechanism 202 (e.g., mechanical arm) can assist the recoating process.

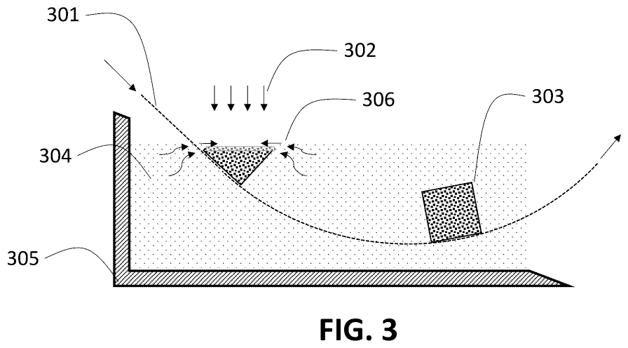

One potential limitation of the top-down and bottom-up systems described herein thus far is that they require resetting the print stage after each article is printed and are not continuous processes. In contrast, FIG. 3 shows an example of a system for printing on a pliable substrate. Here, the pliable substrate can be moved through a vat of the photo-curable resin in a continuous manner while article(s) are printed onto the substrate. UV radiation 302 can be projected onto a surface of a volume of photo-curable resin 304 in a container 305 (e.g., that is exposed to air). The printed article 303 can be printed onto a pliable substrate 301 that is moved through the photo-curable resin. In some cases, if the printing is continuous, a recoating mechanism is not used and recoating 306 proceeds without mechanical assistance.

The 3D printing systems described above may be used to print a variety of articles. The shape of the article and its properties, such as the resolution of fine features, the consistency and extent of cure of the resin may be determined by the combination of many factors such as the mechanical attributes of the system, the chemical attributes of the resin, and the printing methodology. In some aspects, the present disclosure relates to the printing methodology which may include how the printer is operated (e.g., printing speed, continuously or in discrete print layers) and the location and intensity of projected radiation over time.

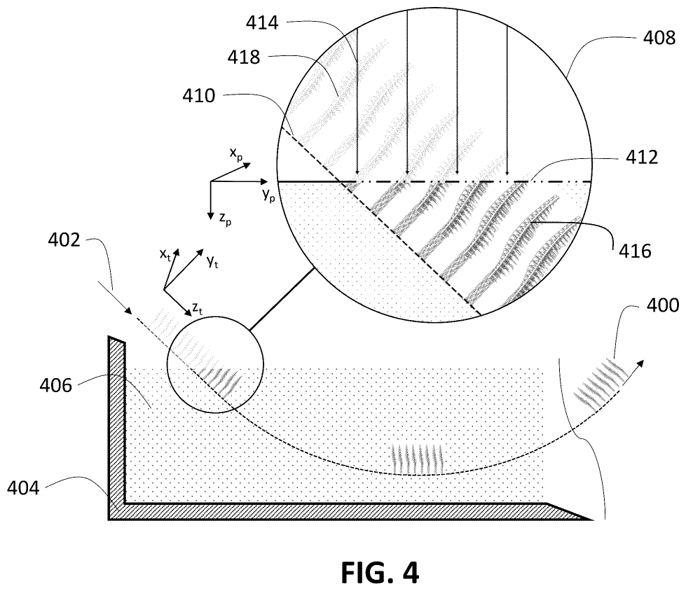

FIG. 4 shows an example of the method of iteration stacking described herein. In some embodiments, the method as shown in FIG. 4 may be used in the printing system shown in FIG. 3, where a pliable substrate may be used. The pliable substrate may enter into a vat of the photo-curable resin at an angle (e.g., an acute angle) relative to the surface of the resin and move through the vat of the photo-curable resin in a continuous manner while article(s) are printed onto the substrate. The method may comprise providing a plurality of additively manufactured iterations of items, which overlap with each other within a single projection layer of the process. Without the iteration stacking methods described herein, it would be necessary to separate iterations from one another and produce them one by one or to compile/slice the files together as a single production file. The former would decrease throughput while the latter would increase file compiling and slicing complexity, slowing down processing times, as well as constraining to print fixed quantities of items at a time. The iteration stacking methods described herein provide a solution to this problem.

Continuing with FIG. 4, the printing methodology computationally “slices” a model of the 3D object to be printed into a series of layers that constitute the 3D object when printed in succession. Here, plurality of articles 400 are being printed on a pliable substrate 402 moved in the direction shown through a vat 404 containing a photo-curable resin 406, where the plurality of articles are repetitions (e.g., iterations) of an article, e.g., parts 416 stacked in a pattern, and the plurality of articles are printed onto the pliable substrate 402. In the example shown in FIG. 4, mascara brushes are affixed to the pliable substrate on one end and extending substantially perpendicularly therefrom. In the close up view 408 the articles (iterations) are printed onto substrate 410 (e.g., pliable substrate 402) at an angle (e.g., a non-right angle, such as an acute angle, e.g., π/4 radians or any other suitable value) with respect to the surface of the resin 412 and are closely packed together. Therefore, the slices of the 3D model may each contain portions of more than one printed article. The UV radiation 414 is directed perpendicular to the surface of the resin 412 in a pattern corresponding to the particular slice being printed at that time.

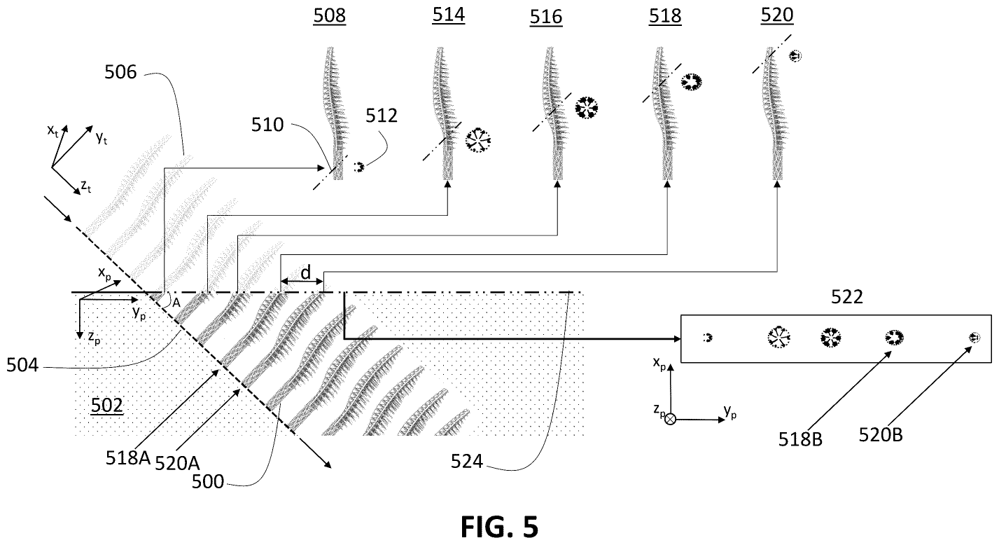

Continuing with the detail magnification, namely, the close up view 408 of FIG. 4, the continuous top-down iteration stacking process as described herein shows already cured and finished parts (and portions thereof) 416 that continue to move further to the bottom right. The lightly shaded parts (and portions thereof) 418 above the surface of the resin 412 depict iterations to be printed in the future. The middle line-double-dotted separation line indicates the resin level of the vat 404, which is also the projection layer for the UV radiation hitting the photopolymer precursor. This layer indicates the layer of curing of liquid photopolymer into cured parts of iterations. Within the same curing layer, iterations are intersected in the same orientation but at different heights relative to the plane of the substrate. This principle may be used by the iteration stacking algorithm. The height offset of the projection layer intersection of the “iteration”, (also referred to herein as “slice layer” or “slice index”), indicates the intersection to project for this iteration. The intersection of one iteration may be merged with other currently intersected (e.g., currently built) iterations, as will be shown in FIG. 5 (see e.g., layer 522, which includes multiple projections).

Returning to FIG. 4, the coordinate systems in FIG. 4 are kept consistent over the course of the subsequent figures and show the projection reference system indicated by xₚ, yₚ, zₚ as well as the transportation reference system indicated by xₜ, yₜ, zₜ. The projection reference system may be used for the processing of voxel projections from the UV projections radiated onto the resin surface level. As shown in FIG. 4, the xₚ-yₚ plane extends over the surface of the resin 412 whereas zₚ axis is perpendicular to the xₚ-yₚ plane and extends in the UV radiation 414 direction. The transportation reference system may be used to describe the cured part and resulting model geometries, as well as their travel direction within the printing system. As shown in FIG. 4, the xₜ-zₜ plane extends across the plane of the pliable substrate 402, e.g., at the entering point into the resin, whereas yₜ axis is perpendicular to xₜ-zₜ plane. Information before the curing process may be described in the projection reference system and transformed into the transportation reference system upon cure. The transportation reference system runs along the trajectory of the pliable substrate.

In some embodiments, methods for continuous 3D printing of a plurality of copies of an article using the systems shown in FIGS. 3 and 4 are described with reference to FIGS. 5-15.

FIG. 5 shows a series of articles 500 being printed and moving through the resin 502 at an angle (e.g., angle A) and affixed to the pliable substrate 504. In some embodiments, angle A may be a non-right angle, e.g., an acute angle. A continuous queue 506 of articles (iterations) are to be printed. For a particular slice, e.g., the slice that extends across the resin surface 524, portions of five different copies of the article (e.g., article 508, 514, 516, 518, 520) intersect with it (and form at least part of the printed slice). For the left-most of these individual articles 508, for that particular slice, a side view of the article 508 (e.g., single article model) is shown, along with the angled intersection cut 510 (e.g., projection layer cut through a single iteration article), and the top-down view 512 (e.g., projection intersection cut through a single iteration article). The same views are shown for the second 514, third 516, fourth 518, and fifth 520 article in this slice. The top view for each of the iteration intersection cuts may be merged into a single projection layer 522 (e.g., for all different iteration intersection positions), which is shown to coincide with the resin surface 524. The coordinate system may help to differentiate substrate, top and side views. For example, the projection layer 522 and the resin surface 524 each extend in the xₚ-yₚ plane.

As shown in FIG. 5, the method for continuous 3D printing of the plurality of copies of an article may include: executing a print file having instructions for printing a first copy of the article, e.g., article 520 or first portion thereof on or near a first segment of a substrate (e.g., area 520A); and subsequently executing the print file to print a second copy of the article, e.g., article 518 or second portion thereof on or near a second segment of the substrate (e.g., area 518A), where the second segment is adjacent to the first segment of the substrate. As shown, the first and second segments, area 518A, 520A, may respectively correspond to two locations (portions) on the substrate 504.

As shown in FIG. 5, resin 502 may be a reservoir of photo-curable resin in a vat (e.g., vat 404 in FIG. 4), where the substrate 504 is moved through the reservoir by a conveyor. In some examples, the substrate 504 may enter into the resin at an acute angle (e.g., angle A) relative to a surface of the resin. This enables multiple copies of an article or portions of the multiple copies of an article to be printed simultaneously, without one copy of the article being printed after the printing of a previous copy of the article is completed. For example, as shown in FIG. 5, portions 518B, 520B corresponding to different copies of the article may be printed at least in part simultaneously, e.g., at the projection layer 522, forming copies of the article 518, 520. As shown, portions 518B, 520B may be adjacent to each other and separated by a gap distance d.

While printing, a projector may project UV radiation at the surface of the photo-curable resin (e.g., in direction zₚ). In some examples, projection may include projecting the radiation at a selected portion of the surface to cure the photo-curable resin in a proximity to the selected portion of the surface, where the cured resin forms the article or portions thereof. For example, projecting the radiation may be performed selectively at portions 518B, 520B, in the direction perpendicular to the resin surface 524, as shown in zₚ.

In some embodiments, selected portions to be printed at projection layer 522 may each include a planar image such as portions 518B, 520B, to be in contact with the radiation from the projector, where the planar image may correspond to a slice of the article (e.g., a 3D model) contained in the print instructions (e.g., print file). In some embodiments, projecting radiation on one or more of the selected portions to be printed may be contained in print instructions. For example, projecting the radiation at the surface of the photo-curable resin may include projecting simultaneously (i) radiation at a first portion of the surface, e.g., planar image—portion 518B, according to instructions provided by a first execution of the print file and (ii) radiation at a second portion of the surface, e.g., planar image—portion 520B, according to instructions provided by a second execution of the print file. In some examples, print instructions may include instructions for controlling the conveyor and controlling the projector.

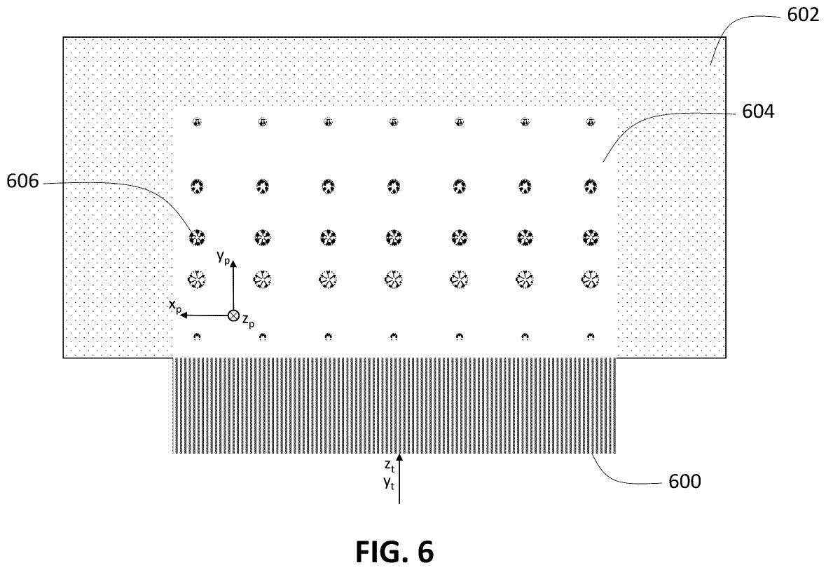

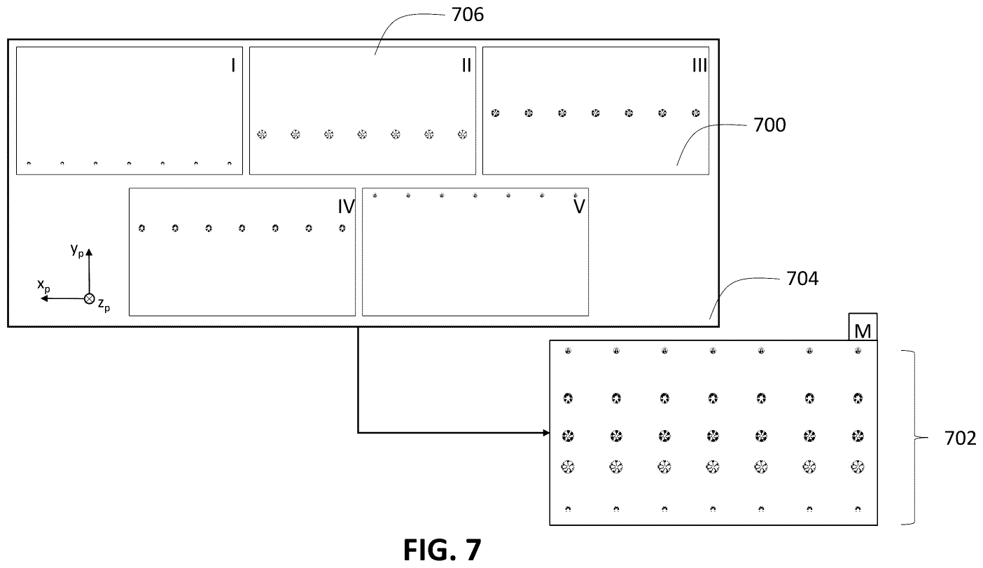

FIG. 6 shows a view of iteration intersection cuts. Here, the pliable substrate 600 moves into the resin pool 602. The articles are cured as the active projection layer 604 (e.g., multiple iteration intersection cuts merged into a single projection layer, such as projection layer 522 in FIG. 5) of the UV radiation is directed onto the surface of the photopolymer precursor. Individual part intersections 606 (each corresponding to an intersection cut projection of a single iteration) may be stacked in a pattern. For example, the individual articles (shown in FIG. 5) for which the intersection cuts are merged into a single projection layer 522 may be seen as arranged in iteration rows, e.g., stacked in a vertical direction (e.g., in yₚ direction in the projection reference system or zₜ direction in the transportation reference system) in the overall merged projection. The top view also illustrates how the iterations may be stacked in a horizontal direction (e.g., xₚ or xₜ) for the merged projection. For the horizontal iteration stacking, the same intersection cut may be copied through the x dimension without any substantial adjustments. In some embodiments, iteration stacking of a single print file (e.g., a mascara brush print file) may be performed throughout both dimensions (e.g., vertical and horizontal stacking), or a combination thereof. For example, iteration stacking may be arranged in a horizontal pattern, a vertical pattern, a diagonal pattern, a circular pattern or any suitable pattern in one dimension or two dimensions. In these various stacking patterns, the printing process may require only the data of the single article and populated iterations throughout the substrate. This is further illustrated in embodiments described further herein, e.g., in FIG. 7.

FIG. 7 shows a schematic diagram of an example of merging stacked iteration projections, in accordance with some embodiments of the present disclosure. Shown in FIG. 7 is an intersection cut of a single iteration row at position III index (or interchangeable, layer) 700. As shown, intersection cuts of an article (in this case a row of same file iterations) may be represented at different position (e.g., positions I, II, III, IV, V, etc.) index cuts of the file and fused together into a merged iteration stacked projection layer 702. In the example in FIG. 7, a total of five (I, II, III, IV, V) intersection cuts 704 of iteration cuts are intersecting the current projection layer 702, and thus, are fused. The resulting fused iteration stacking projection may be an aggregate of all different position index cuts max value summed together. As used herein, “max value summed” means that the maximum pixel value from overlapping layers will be selected, where the pixel values at a given pixel position for a given layer may include the intensity indicating the UV radiation being projected. Overlapping, as used herein, may include examples where two layers or portions of two layers meet at a same position (xₚ, yₚ), as illustrated in further examples herein. In a non-limiting example, if two areas of position index II 706 and position index III were to overlap in projection areas and the pixel value in layer position index II (PII) at position xₚ=150, yₚ=200 is PII=180 and in layer position index III (PIII) at position xₚ=150, yₚ=200 is PIII=210, the merged projection layer will have a pixel value at xₚ=150, yₚ=200 of PM=210 (and not 390). An iteration stackable file should not overlap itself at different iteration positions, in accordance with some embodiments. In other words, an instance (iteration) of an article should not overlap with another instance (iteration) of the same article at a different iteration position. However, in practice this may happen. Picking the max value for the merged projection layer may reduce the errors introduced throughout the fuse operation.

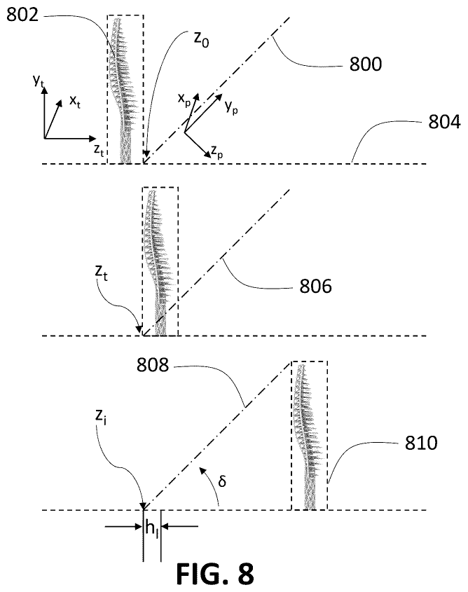

FIG. 8 shows schematic diagrams of an example of a single iteration bounding box and projection length, in accordance with some embodiments of the present disclosure. FIG. 8 depicts the side view of three length metrics for an iteration stacking article (e.g., to determine separation distances for stacking them, as well as their total duration for projections in time and space). The lengths here are determined in the transportation reference system in zₜ orientation. The first two measurements are given through the minimal cubic bounding box of the article's geometry from minimal z starting position z₀ and maximum z end position zₜ. These measurements are illustrated in the top and middle drawings in FIG. 8, indicating the slice intersection plane 800 for the part correspondingly at these positions. The intersection plane may be the same as the resin layer during the eventual manufacturing process of the part. Shown here in particular are: Projection Intersection Cut Layer at Index Position 0; Side View of Single Part Iteration Row 802; Movable Carrier Substrate 804; Projection Intersection Cut Layer at Index Position zₜ 806; Projection Intersection Cut Layer at Index Position zᵢ 808; and Projection Bounding Box 810 of the Parts Iteration Row.

The measurement in zᵢ in FIG. 8 indicates the z position for the last slice projection necessary to complete the full part. This value may be obtained based on the maximum height (z_{bmax} in zₜ direction) and length (y_{bmax}, in yₜ direction) of the part as well as the process manufacturing angle δ, e.g., π/4 radians. As shown in FIG. 8, z_{bmax} and y_{bmax} may form the bounding box shown in dotted line, e.g., box 810. The parameters are related through trigonometric function:

$${z}_{i} = {z}_{t} + [ cos ( δ ) * {y}_{bmax} / sin ( δ ) = {z}_{t} + [ {y}_{bmax} * cot ( δ ) ]$$

and for the special case of δ=π/4 radians with tan (π/4)=1

$${z}_{i} = {z}_{y} + {y}_{bmax}$$

The overall length Δz from position z₀ to position zᵢ may be used to determine the overall length of projection necessary to manufacture a single part iteration of the file. Based on the overall length and the spatial dimensions, ns for the overall number of slices projected may be determined. For example, with a process layer height of hₗ, the number of slices is nₛ=zᵢ/hₗ. In the example shown, both zᵢ and hᵢ may be measured in the transportation reference system. For example, zᵢ may be measured in the zₜ direction, and hₗ may be measured in the zₜ direction parallel to the substrate. To offset the model for Δz_{offset} into substrate dimension, the projection index timings start index may be offset by n_{offset}=Δz_{offset}/hₗ.

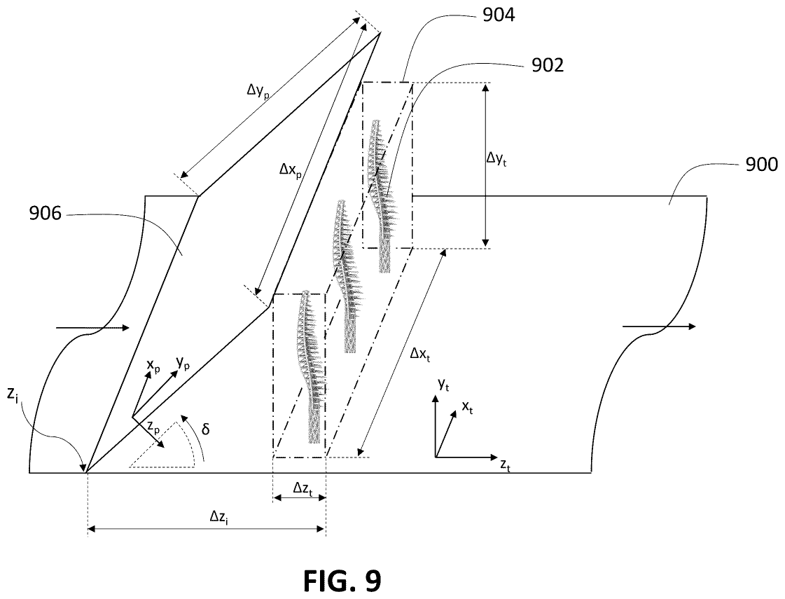

FIG. 9 shows another schematic diagram of an example of a single iteration bounding box and projection length, in accordance with some embodiments of the present disclosure. Here, the pliable substrate 900 has multiple articles 902 printed on it. A projection bounding box 904 of the article's iteration row is shown. The projection intersection cut plane 906 is shown at index position zᵢ. The parameters and measurements of FIG. 9 are discussed in the description of FIG. 8 above. FIG. 9 further shows the geometric lengths of the manufacturing process in 3D. Additionally, the parts bounding box dimensions may be shown in this 3D view (visualized as Δxₜ, Δyₜ, Δzₜ). In FIG. 9, the projection dimension, e.g., the maximum dimensions of the projection plane, are illustrated as Δxₚ, Δyₚ. This perspective may give an additional view of the single iteration setup and manufacturing process.

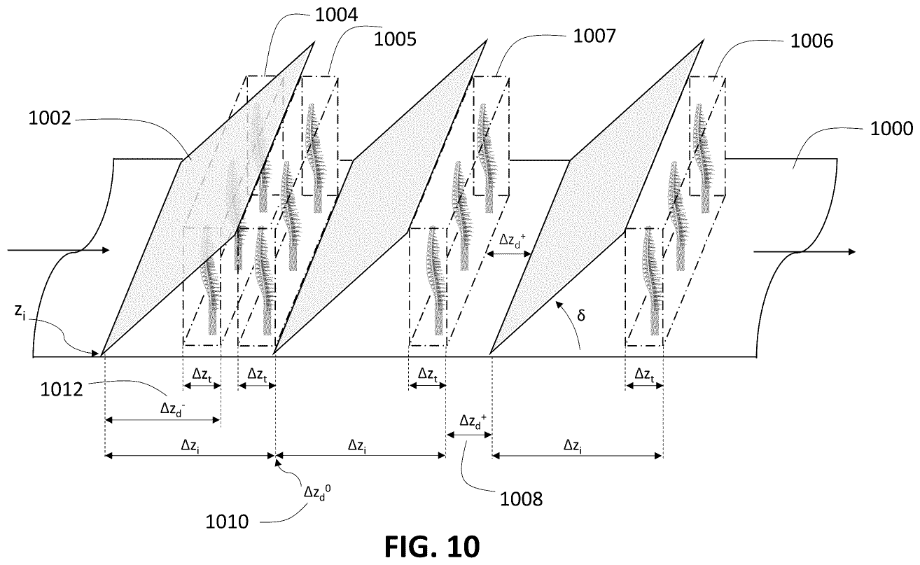

FIG. 10 is a schematic diagram showing the geometric descriptors of iteration stacking including the separation distance of articles, e.g., to determine the sequencing of multiple iterations manufactured in a row. FIG. 10 shows separation distances and the offsetting of multiple iterations behind one another. Here, a plurality of articles are printed on to a pliable substrate 1000. The projection intersection cut plane 1002 is shown at index position zᵢ for the first iteration. In some cases, a negative separation distance (Δz_{d}⁻) 1012 is shown, e.g., between stacked iteration rows 1004 and 1005. In some instances, a positive separation distance (Δz_{d}⁺) 1008 is shown, e.g., between stacked iteration rows 1007 and 1006. In some instances, a projection bounding box of the parts iteration row 1006 is shown.

Iteration stacking may include positive, zero, and negative separation distance between rows of articles to be manufactured. Starting from the right side of the substrate distance (Δz_{d}⁺) 1008 indicates a positive separation distance in-between two part iterations, e.g., iteration rows 1006 and 1007. The separation distance may be used to determine the distance separating the previous iteration from the next one to be printed, as measured from the last projection of the prior iteration, e.g., its zᵢ position on the substrate and the z₀ of the following iteration. For the case of a zero-separation distance this length is set to 0 and the projections are done back-to-back, e.g., as soon as the last slice of the prior iteration has been projected, the first slice of the next iteration is projected. Therefore, a zero 1010 (Δz_{d}⁰) is shown.

Iteration stacking may be configured with negative separation distances Δz_{d}⁻ for which the next iteration is started being printed before the prior iteration is finished, so that multiple iterations may be manufactured in parallel at different stages of completion within the same projection plane and UV projection. For example, a negative separation distance (Δz_{d}⁻) 1012 is shown between stacked iteration rows 1004 and 1005. The distance from the start of one iteration to the next iteration on the substrate may be calculated to Δz_{offset}=Δzᵢ−Δz_{d}⁻ and may be used to determine the packing density of part iterations on the substrate. Based on the distance between multiple part iterations, the offset of slice index for the position of the intersection cut height may be calculated to be projected in parallel for multiple part iterations. For distance, for Δz_{offset}=Δzᵢ−Δz_{d}⁻, between two iterations with a layer height of hₗ, the index offset may be calculated to be n_{offset}=ceiling (Δz_{offset}/hₗ). As used herein, the ceiling function rounds any fractional number up to the next integer (or down to the next integer in the case of negative numbers).

Having described geometric descriptors of iteration stacking, it is appreciated that a conveyor may move the substrate at a gap distance between beginning of a first execution of the print file and beginning a subsequent execution of the print file. As shown in FIG. 10, the gap distance may be less than a distance on the substrate onto which a single copy of the article is printed, as indicated by a negative separation distance Δz_{d}⁻. As such, a first execution of the print file (e.g., a first iteration) and a subsequent execution of the print file (e.g., a second iteration) may occur simultaneously, or at least partially simultaneously. In case of negative separation distance, an iteration time period, which passes between beginning of a first execution of the print file and beginning a subsequent execution of the print file, may be less than an execution time period between beginning and ending of an execution of the print file. As such, iteration stacking results in a reduction of gap in space and time in comparison to existing 3D printing of multiple articles.

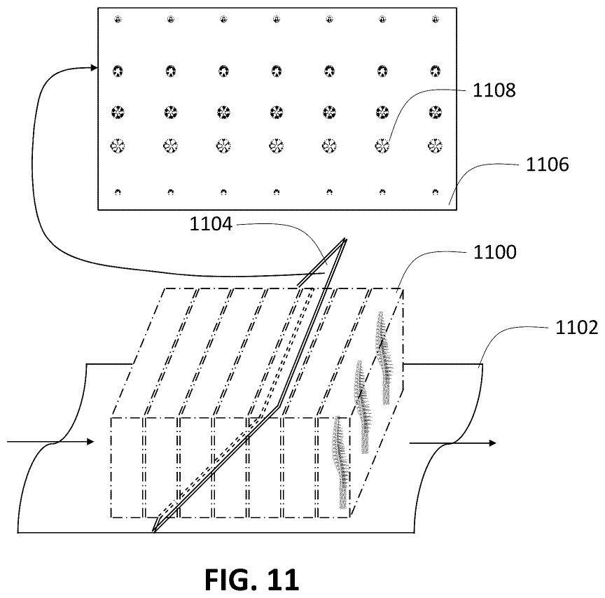

FIG. 11 shows an intersection cut of stacked iteration volumes. As shown here, multiple projection bounding boxes 1100 including rows of articles being manufactured are placed on a pliable substrate 1102. A projection intersection cut plane 1104 intersects multiple iterations of the bounding box (e.g., rows of articles). The intersection may be at any suitable angle, e.g., the angle that the pliable substrate enters the reservoir of polymeric precursor. A top-down view 1106 of the projection layer (e.g., along the direction of UV light irradiation) is shown, which constitutes a merger into a single projection layer of multiple cut intersections 1108 for multiple iterations (printings) of the articles.

As shown in FIG. 11, multiple stacked iterations with an intersection cut through may show how iteration stacking as described herein may result in efficient additive manufacturing (e.g., a large number of printed articles per time and/or volume). Multiple part iterations at different intersection cut heights within the process may be manufactured within the same merged projection plane.

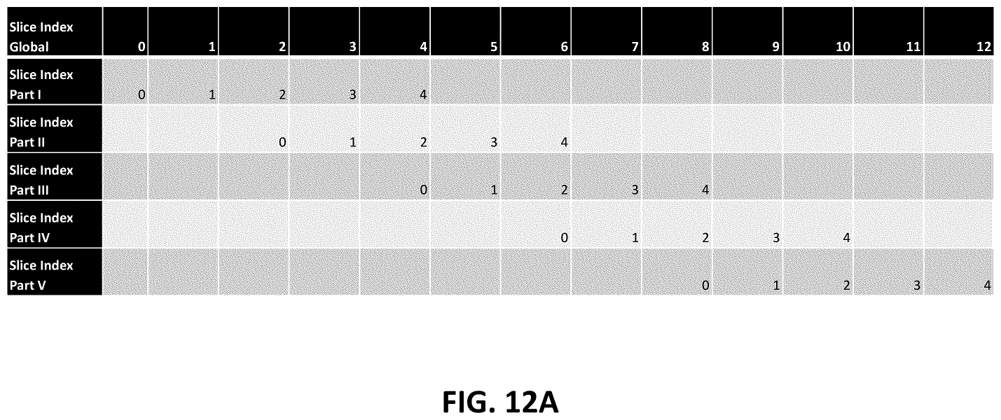

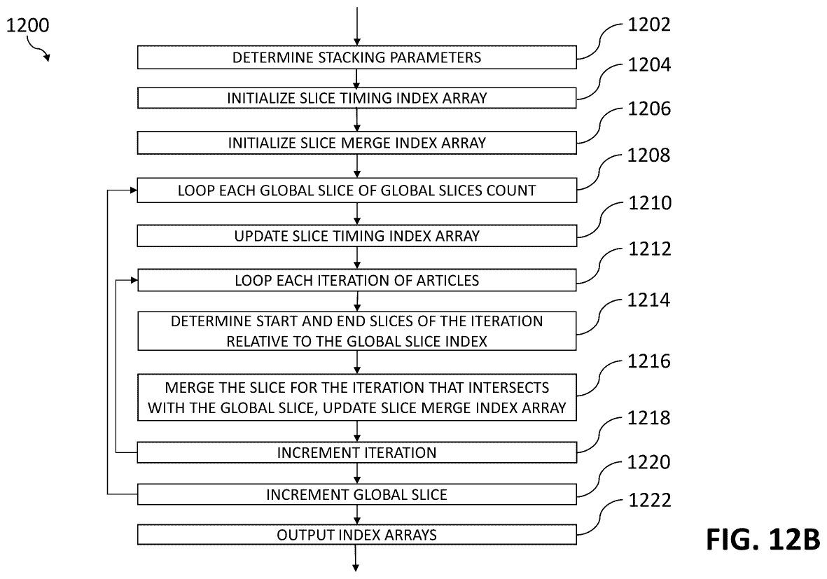

FIG. 12A shows a table which represents the implementation of the methods described herein on the code level within the machine's firmware. The table provides an overview of which slice index is projected for a certain moment in time of the iteration stacked print job to produce, in this example i=5 stacked iterations of an article which has a total slice number of nₜₒₜₐₗ=5 slices with a layer height of hₗ=1 millimeter (mm) and a separation distance of Δz_{d-}=3 mm. Using these parameters, the index offset and the total global slice numbers (slices count) may be determined such that:

$${n}_{offset} = ceiling [ Δ {z}_{offset} / {h}_{l} ] = ceiling [ ( Δ {z}_{i} - Δ {z}_{d -} ) / {h}_{l} ] = ceiling [ 2 mm / 1 mm ] = 2$$

$${n}_{global} = {n}_{offset} \times ( i - 1 ) + {n}_{total} = 2 \times ( 5 - 1 ) + 5 = 2 \times 4 + 5 = 13$$

With reference to FIG. 12A, each vertical column for a global slice index shows which slices are printed at that point in time. For example, at overall Global Slice Index 4, slice index 4 for Part I is to be printed as well as slice index 2 for Part II and slice index 0 for Part III. For Global Slice Index 7 the merged projection contains the fused slices of Part III slice index 3 and Part IV slice index 1 at the same time.

The code (e.g., represented by the table in FIG. 12A) that controls the printing process may keep a list of integers of the same length as the number of iterations (number of times the part is to be printed). In some embodiments, each index of the list corresponds to the number of slices printed of the i-th part. Initially, each value is −1 except for the zero-index list [0] which is set to 0.

At any given time, the projection plane may merge all slices of the part iterations that have a value between 0 and nₜₒₜₐₗ (e.g., the total slice number). After loading all slices and merging them together into a singular fused projection for the current layer, all integers may be incremented by 1. If the last non-negative element of the index list is equal to n_{offset}, then the first negative element of the list is set to 0. This indicates that another part has begun, so the first slice of that part will then be included in the display when the next set of slices is displayed. For a globally fully finished iteration stacked job, the list will have all iteration counters within said list at nₜₒₜₐₗ, indicating all iterations have all slices projected up until the highest part slice index of nₜₒₜₐₗ.

FIG. 12B shows a flow diagram of an example process for iteration stacking. In some examples, method 1200 shown in FIG. 12B may be implemented to generate the code for controlling the printing process e.g., the table in FIG. 12A. In some embodiments, method 1200 may include determining stacking parameters, at act 1202. In some examples, the method may obtain user input and determine the stacking parameters based on the user input. In non-limiting examples, the user input may include print instructions such as one or more of the number of iterations of articles, slice count (e.g., the number of slices for each iteration), slice height (e.g., the height of each slice, e.g., in mm), slice angle (e.g., the entry angle for the substrate, e.g., in radians, such as angle A in FIG. 5), or instructions for controlling the conveyor and controlling the projector, such as print speed (e.g., mm per second), separation distance (e.g., in mm).

In non-limiting examples, the stacking parameters may include the parameters converted to the transportation reference system. For example, the stacking parameters may include the slide height along the substrate (e.g., zₜ direction in mm), which may be determined based on the slice height divided by the sinusoidal of the slice angle. The stacking parameters may also include the timing between slices along the substrate (e.g., zₜ direction in seconds), which may be based on the slice height along the substrate divided by the print speed. The stacking parameters may include a separation distance by slice count, which may be based on the separation distance divided by the slice height along the substrate. In non-limiting examples, the stacking parameters may include a global slices count n_{global}. For example, the global slices count (e.g., shown as the total number of columns in FIG. 12A) may be determined based on the number of iterations multiplied by sum of slice counts and the separation distance by slice count. This considers both the slice counts for each iteration and the separate distance between adjacent iterations.

Additionally, and/or alternatively, method 1200 may include initializing the output, such as slice timing index array, at act 1204, and slice merge index array, at act 1206. In some examples, the slice timing index array may be of one-dimension, where each value in the array may indicate timing for slice flips. For example, [0 0.15 0.3 0.45 . . . 15.15] may indicate switching projection at 0 s, 0.15 s, 0.3 s, 0.45 s, etc. In some examples, the slice merge index array may be of 2D and contain values to indicate which slice indices to merge for each projection in the slice timing index array. For example, for a given projection, [3 53 103 −1 −1] may indicate merging slices with index 3 53 103, respectively for the first, second, and third iterations, where value “−1” indicates none for the fourth and fifth iterations. Thus, initializing the slice timing index array may include assigning value zero to the array. Initializing the slice merge index array may include assigning value “1” to the array. Further acts in method 1200 may be implemented to update the slice timing index array and slice merge index array.

With further reference to FIG. 12B, method 1200 may include looping for each global slice of the global slices count, at acts 1208 through 1220. For each global slice in the loop, method 1200 may update slice timing index array, at act 1210. For example, act 1210 may update the slice timing index array with the timing between slices along the substrate. In some examples, the timing between slices along the substrate may be part of stacking parameters and determined, e.g., at act 1202. For each global slice in the loop, method 1200 may loop for each of the iterations of articles, at acts 1212 through 1218. For each iteration in the loop, method 1200 may determine start and end slices of the iteration relative to the global slice index, at act 1214, and determine the slice(s) for the iteration to merge in the global slice in the global slice loop, at act 1216. In some examples, act 1216 may merge the slice for the iteration that intersects with the global slice in the global slice loop and update slice merge index array with the merged slice index (indices). In some examples, merging of slices will result in the same layer height. For example, merging of slices 1,2,3,4,5 each of the same layer height (e.g. 22 micron) may result in a single merged slice of the same layer height (22 micron). When the iteration loop at acts 1212 through 1218 is complete, method 1200 increments the global slice at act 1220 until the global slice loop at acts 1208 through 1220 is complete. Then, method 1200 may output the index arrays, such as outputting the slice timing index array and/or slice merge index array, at act 1222.

Although FIG. 12B shows an example process for iteration stacking, it is appreciated that suitable variations may be possible. For example, the acts performed as part of the method(s) may be ordered in any suitable way. In non-limiting examples, the loops for global slice (act 1208) and iteration (act 1212) may be interchangeable. In other variations, any of acts 1202, 1204, 1206 may be performed in any suitable order.

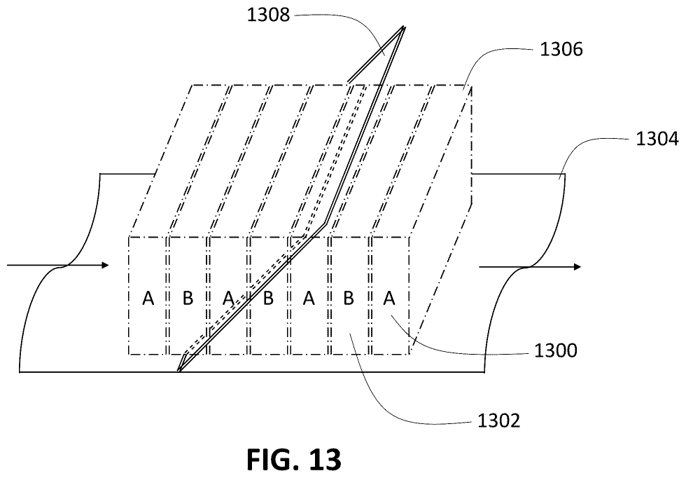

FIG. 13 shows an example of stacked iterations having an alternating periodical pattern. Here, there are two types of articles or portions thereof denoted A 1300 and B 1302 to be printed on a pliable substrate 1304. A bounding box 1306 surrounds the articles (in this case, of type A). A projection intersection cut plane 1308 may intersect multiple iterations of type A and/or type B. In this case, there is a negative separation distance, e.g., between two adjacent stacked iterations (e.g., type A followed by type B) or between two adjacent periodical patterns (e.g., AB followed by AB).

Continuing with FIG. 13, an iteration stacking print job which may have a sequence or pattern of different types of bounding boxes. Iteration stacking jobs may have an additional property assigned to them indicating a pattern of repetition, or the iterations to occur in the global printing job. In this setup, iteration stacking of two different types of articles (of type A and type B) are iteration-stacked together with a negative separation distance, e.g., to be as densely packed as possible on the substrate and run with highest print speed and volume efficiency. File type A and type B may be sliced and referenced once, as for the standard iteration stacking methods described herein, and have an additional parameter representing the periodical pattern added to them like (A,B). Other variations such as (A,B,C,A) are further embodiments of the same principle. The example shown in FIG. 13 would be described in the notation as: {[(A,B), 3, 0], [(A, ), 1, 0])]}; where { } contains the overall sequence of articles including one or more patterns. [ ] indicates one pattern comprising a sequencing pattern in ( ) followed by the iterations count as well as the distance gap to the prior part “,” separated behind it.

In an iterative stacking print job such as shown in FIG. 13, a print file (e.g., print file for article A) may be executed multiple times, each printing a copy of the article. For example, A in notation {[(A,B), 3, 0], [(A, ), 1, 0])]} may reference to a print file A and thus, iterative stacking executes print file A multiple times. In some examples, iterative stacking printing may execute a second print file (e.g., print file B) between a first and a subsequent execution of the print file (e.g., print file A), as shown in the notation above.

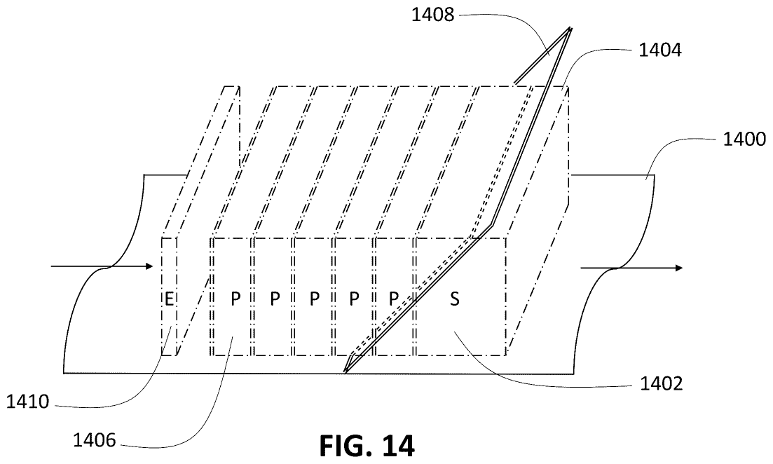

FIG. 14 shows a schematic diagram of an example of stacked iterations having a starting and/or ending file, in accordance with some embodiments of the present disclosure. Here, the articles are printed on the pliable substrate 1400 from right to left. The starting file 1402 may have a corresponding bounding box 1404 associated with it. This example has a negative separation distance, which results in multiple periodical iterations of the bounding box for each iteration of the articles 1406 intersecting with the projection intersection cut plane 1408. Finally, an ending file 1410 may be printed. In some embodiments, each of the starting file and ending file may include instructions for printing the article, a support structure (e.g., a scaffold) to support the article, combinations thereof, or portions thereof which are not printed as a result of executing the print file.

Continuing with FIG. 14, iteration stacking may use starter and ender notations in the iteration stacked setup. In some embodiments, the starting and ending files may be printed only once rather than iteratively, for example, to print a scaffold for the articles, or to finish printing the trailing edge of the articles and/or the supports. The main working principle is the same as for the periodical sequencing iteration stacking with the addition that files are referenced that are not repeated throughout the global job: {starter, [periodical, . . . ], ender}. In the example shown in FIG. 14, the parameters would be set to: {[(S, ), 1, 0])], [(P, ), 5, 0], [(E, ), 1, 5])]}.

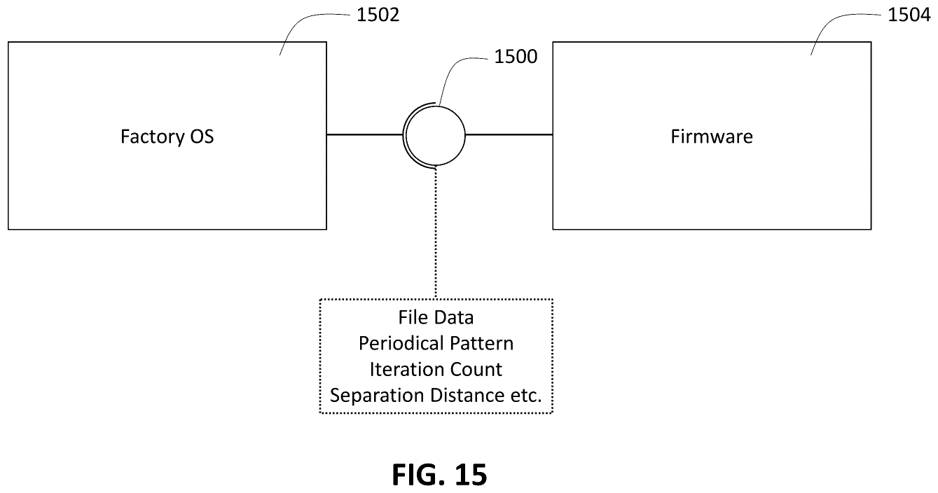

FIG. 15 shows a schematic diagram of an example of a printing system, in accordance with some embodiments of the present disclosure. Here, a communication interface 1500 between a server 1502 (e.g., a processor on a server or on the cloud) and machine operating firmware 1504 (e.g., in the 3D printer) may be created to execute iteration stacking production jobs. In the example shown, the server 1502 may be Factory OS, e.g., the server-side production management. The data transmitted through the communication interface (e.g., from server 1502 to machine (printer) operating firmware 1504) may contain the file data containing instructions such as a reference of the ID's of parts to be produced (repeated) and the periodical pattern for how to sequence them. The setup (e.g., performed by the operator) may also include the global iteration stacked job parameters including the iteration counts as well as separation distances.

Although FIG. 15 shows communication between the server and machine operating firmware, it should be appreciated that any variation of this configuration may be suitable. For example, the server 1502 may be co-residing with the machine operating firmware inside the 3D printing system. Also, it should be appreciated that one or more 3D printing systems may be used to implement the systems and methods described herein. For example, some embodiments may be used in conjunction with one or more systems described in U.S. Patent application Ser. No. 16/552,382, filed Aug. 27, 2019, or U.S. patent application Ser. No. 17/668,503, filed Feb. 10, 2022, each of which is incorporated herein in its entirety. However, it should be appreciated that other printer methods and systems may be used with embodiments as described herein.

The printing method may be stereolithographic, or involve deposition, sintering or melting techniques such as fused deposition modelling, selective laser sintering or selective laser melting processes (e.g., which might not use photopolymers).

The systems and methods described herein may be implemented using any suitable computational method or file format, such as described in PCT Patent Application Serial Number PCT/US2021/023962, filed Mar. 24, 2021, which is incorporated herein in its entirety.

The above-described embodiments may be implemented in any of numerous ways. For example, the embodiments may be implemented using hardware, software or a combination thereof. When implemented in software, the software code may be executed on any suitable processor or collection of processors, whether provided in a single computer or distributed among multiple computers. It should be appreciated that any component or collection of components that perform the functions described above may be generically considered as one or more controllers that control the above-discussed functions. The one or more controllers may be implemented in numerous ways, such as with dedicated hardware or with one or more processors programmed using microcode or software to perform the functions recited above.

In this respect, it should be appreciated that one implementation of the embodiments of the present disclosure comprises at least one non-transitory computer-readable storage medium (e.g., a computer memory, a portable memory, a compact disk, etc.) encoded with a computer program (e.g., a plurality of instructions), which, when executed on a processor, performs the above-discussed functions of the embodiments of the present disclosure. The computer-readable storage medium may be transportable such that the program stored thereon may be loaded onto any computer resource to implement the aspects of the present disclosure discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that may be employed to program a processor to implement the above-discussed aspects of the present disclosure.

Various aspects of the present disclosure may be used alone, in combination, or in a variety of arrangements not specifically discussed in the embodiments described in the foregoing and are therefore not limited in their application to the details and arrangement of components set forth in the foregoing description or illustrated in the drawings. For example, aspects described in one embodiment may be combined in any manner with aspects described in other embodiments.

Also, embodiments described in the present disclosure may be implemented as one or more methods, of which an example has been provided. The acts performed as part of the method(s) may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments in detail, various modifications and improvements will readily occur to those skilled in the art. Such modifications and improvements are intended to be within the spirit and scope of the present techniques. Accordingly, the foregoing description is by way of example only, and is not intended as limiting.

Various aspects are described in this disclosure, which include, but are not limited to, the following aspects:
(1) A method for continuous 3D printing of a plurality of copies of an article, the method comprising: executing a print file having instructions for printing a first copy of the article or first portion thereof on or adjacent to a first segment of a substrate; and subsequently executing the print file to print a second copy of the article or second portion thereof on or adjacent to a second segment of the substrate, wherein the second segment is adjacent to the first segment of the substrate.
(2) The method of aspect 1, wherein the print file is executed a plurality of times.
(3) The method of any of aspects 1 and 2, further comprising executing a second print file between a first and a subsequent execution of the print file.
(4) The method of any of aspects 1-3, wherein printing the first copy and the second copy of the article each comprises: by a conveyor, conveying the substrate through a reservoir of photo-curable resin.
(5) The method of aspect 4, wherein conveying the substrate through the reservoir of photo-curable resin comprises moving the substrate into the reservoir at an acute angle relative to a surface of the resin.
(6) The method of any of aspects 4 and 5, wherein printing the first copy and the second copy of the article each further comprises: by a projector, projecting radiation at a surface of the photo-curable resin.
(7) The method of aspect 6, wherein projecting the radiation at the surface of the photo-curable resin comprises: projecting the radiation at a selected portion of the surface to cure the photo-curable resin in a proximity to the selected portion of the surface; wherein the cured resin forms the article or portions thereof.
(8) The method of aspect 7, wherein the instructions comprise a plurality of substantially planar images of the surface of the photo-curable resin; wherein projecting the radiation comprises contacting the plurality of substantially planar images with radiation.
(9) The method of any of aspects 7 and 8, wherein the instructions comprise instructions for controlling the conveyor and controlling the projector.
(10) The method of any of aspects 7-9, wherein projecting the radiation at the surface of the photo-curable resin comprises projecting simultaneously (i) radiation at a first portion of the surface according to instructions provided by a first execution of the print file and (ii) radiation at a second portion of the surface according to instructions provided by a second execution of the print file.
(11) The method of aspect 10, wherein the first portion of the surface and the second portion of the surface are separated by a gap distance.
(12) The method of aspect 11, further comprising: by the conveyor, conveying the substrate at the gap distance between beginning a first execution of the print file and beginning a subsequent execution of the print file.
(13) The method of any of aspects 11 and 12, wherein the gap distance is less than a distance on the substrate onto which a single copy of the article is printed.
(14) The method of any of aspects 1-13, wherein an iteration time period passed between beginning a first execution of the print file and beginning a subsequent execution of the print file is less than an execution time period passed between beginning and ending of an execution of the print file.
(15) The method of any of aspects 1-14, wherein the first portion of the article and second portion of the article are adjacent to each other, thereby forming a copy of the article.
(16) The method of any of aspects 1-15, wherein the instructions comprise a plurality of substantially planar slices of a 3D model of the article.
(17) The method of any of aspects 1-16, wherein the execution of the print file and the subsequent execution of the print file occur at least partially simultaneously.
(18) The method of any of aspects 1-17, wherein at least two instances of the print file are executed simultaneously.
(19) The method of any of aspects 1-18, further comprising executing a starting print file prior to executing a first instance of the print file.
(20) The method of aspect 19, wherein the starting print file has instructions for printing the article, a support structure, combinations thereof, or portions thereof which are not printed as a result of executing the print file.
(21) The method of any of aspects 1-20, further comprising executing an ending print file subsequent to executing a final instance of the print file.
(22) The method of aspect 21, wherein the ending print file has instructions for printing the article, a support structure, combinations thereof, or portions thereof which are not printed as a result of executing the print file.
(23) The method of any of aspects 1-22, wherein the instructions are further configured to print a scaffold which supports any of the articles.
(24) A system for continuous 3D printing of a plurality of copies of an article, the system comprising: a 3D printer having (i) a reservoir of photo-curable resin, (ii) a conveyor configured to convey a substrate through the reservoir of photo-curable resin, and (iii) a projector configured to project radiation at a surface of the photo-curable resin; and at least one processor configured to perform one or more operations in any of aspects 1-23.
(25) A non-transitory computer readable medium comprising: one or more files each representing a respective article for printing and further containing first instructions for 3D printing the respective article; and second instructions for controlling a 3D printer to print a plurality of articles represented in the one or more files on a substrate at least partially simultaneously, wherein the second instructions comprise: (i) a respective number of iterations for each of the plurality of articles to be printed on the substrate; and (ii) a gap distance between adjacent articles of the plurality of articles to be printed on the substrate.
(26) The non-transitory computer readable medium of aspect 25, further comprising a starting file and/or an ending file, each containing instructions for printing an article, a support structure, combinations thereof, or portions thereof which are not printed as a result of executing any of the one or more files.
(27) The non-transitory computer readable medium of aspect 26, wherein the instructions in each of the one or more files or the starting file and/or ending file, and/or the second instructions are configured to perform one or more operations in any of aspects 1-23.
(28) A 3D printed article, comprising: a plurality of copies of an article printed on a substrate; wherein: (i) a first layer of a first copy of the article and a second layer of a second copy of the article extend in a projection plane and are printed simultaneously; and (ii) the substrate is moved into a reservoir of resin at an angle relative to a surface of the resin during printing, wherein the angle is an acute angle.
(29) The 3D printed article of aspect 28, wherein the substrate is a pliable substrate.
(30) The 3D printed article of any of aspects 28 and 29, further comprising: a second article printed on the substrate and disposed adjacent to the first copy of the article, wherein a third layer of the second article extends in the projection plane and is printed simultaneously while the first layer of the first copy of the article and the second layer of the second copy of the article are being printed.
(31) The 3D printed article of aspect 30, wherein the second article is a support structure for at least the first copy of the article.
(32) The 3D printed article of any of aspects 28-31. wherein the plurality of copies of the article are printed using one or more operations in any of aspects 1-23.

What is claimed is:

1. A method for continuous 3D printing of a plurality of copies of an article, the method comprising:
executing a print file having instructions for printing a first copy of the article or first portion thereof on or adjacent to a first segment of a substrate; and
subsequently executing the print file to print a second copy of the article or second portion thereof on or adjacent to a second segment of the substrate, wherein the second segment is adjacent to the first segment of the substrate.

2. The method of claim 1, wherein the print file is executed a plurality of times.

3. The method of claim 1, further comprising executing a second print file between a first and a subsequent execution of the print file.

4. The method of claim 1, wherein printing the first copy and the second copy of the article each comprises:
by a conveyor, conveying the substrate through a reservoir of photo-curable resin.

5. The method of claim 4, wherein conveying the substrate through the reservoir of photo-curable resin comprises moving the substrate into the reservoir at an acute angle relative to a surface of the photo-curable resin.

6. The method of claim 5, wherein printing the first copy and the second copy of the article each further comprises:
by a projector, projecting radiation at the surface of the photo-curable resin.

7. The method of claim 6, wherein projecting the radiation at the surface of the photo-curable resin comprises:
projecting the radiation at a selected portion of the surface to cure the photo-curable resin in a proximity to the selected portion of the surface;
wherein the cured photo-curable resin forms the article or portions thereof.

8. The method of claim 7, wherein the instructions comprise a plurality of substantially planar images of the surface of the photo-curable resin;
wherein projecting the radiation comprises contacting the plurality of substantially planar images with radiation.

9. The method of claim 8, wherein the instructions comprise instructions for controlling the conveyor and controlling the projector.

10. The method of claim 9, wherein projecting the radiation at the surface of the photo-curable resin comprises projecting simultaneously (i) radiation at a first portion of the surface according to instructions provided by a first execution of the print file and (ii) radiation at a second portion of the surface according to instructions provided by a second execution of the print file.

11. The method of claim 10, wherein the first portion of the surface and the second portion of the surface are separated by a gap distance.

12. The method of claim 11, further comprising:
by the conveyor, conveying the substrate at the gap distance between beginning a first execution of the print file and beginning a subsequent execution of the print file.

13. The method of claim 12, wherein the gap distance is less than a distance on the substrate onto which a single copy of the article is printed.

14. The method of claim 13, wherein an iteration time period passed between beginning a first execution of the print file and beginning a subsequent execution of the print file is less than an execution time period passed between beginning and ending of an execution of the print file.

15. The method of claim 1, wherein the first portion of the article and second portion of the article are adjacent to each other, thereby forming a copy of the article.

16. The method of claim 1, wherein the instructions comprise a plurality of substantially planar slices of a 3D model of the article.

17. The method of claim 1, wherein the execution of the print file and the subsequent execution of the print file occur at least partially simultaneously.

18. The method of claim 1, wherein at least two instances of the print file are executed simultaneously.

19. The method of claim 1, further comprising executing a starting print file prior to executing a first instance of the print file.

20. The method of claim 19, wherein the starting print file has instructions for printing the article, a support structure, combinations thereof, or portions thereof which are not printed as a result of executing the print file.

21. The method of claim 1, further comprising executing an ending print file subsequent to executing a final instance of the print file.

22. The method of claim 21, wherein the ending print file has instructions for printing the article, a support structure, combinations thereof, or portions thereof which are not printed as a result of executing the print file.

23. The method of claim 1, wherein the instructions are further configured to print a scaffold which supports any of the copies.

24. A system for continuous 3D printing of a plurality of copies of an article, the system comprising:
a 3D printer having (i) a reservoir of photo-curable resin, (ii) a conveyor configured to convey a substrate through the reservoir of photo-curable resin, and (iii) a projector configured to project radiation at a surface of the photo-curable resin; and
at least one processor configured to perform a method for continuous 3D printing of the plurality of copies of an article, the method comprising:
executing a print file having instructions for printing a first copy of the article or first portion thereof on or adjacent to a first segment of a substrate; and
subsequently executing the print file to print a second copy of the article or second portion thereof on or adjacent to a second segment of the substrate, wherein the second segment is adjacent to the first segment of the substrate.

25. A non-transitory computer readable medium comprising:
one or more files each representing a respective article for printing and further containing first instructions for 3D printing the respective article; and
second instructions for controlling a 3D printer to print a plurality of articles represented in the one or more files on a substrate at least partially simultaneously, wherein the second instructions comprise:
a respective number of iterations for each of the plurality of articles to be printed on the substrate; and
a gap distance between adjacent articles of the plurality of articles to be printed on the substrate.

26. The non-transitory computer readable medium of claim 25, further comprising a starting file and/or an ending file, each containing instructions for printing an article, a support structure, combinations thereof, or portions thereof which are not printed as a result of executing any of the one or more files.

27. The non-transitory computer readable medium of claim 26, wherein the instructions in each of the one or more files or the starting file and/or ending file, and/or the second instructions are configured to perform a method for continuous 3D printing of a plurality of copies of the article, the method comprising:
executing a print file having instructions for printing a first copy of the article or first portion thereof on or adjacent to a first segment of a substrate; and
subsequently executing the print file to print a second copy of the article or second portion thereof on or adjacent to a second segment of the substrate, wherein the second segment is adjacent to the first segment of the substrate.

28. A 3D printed article, comprising:
a plurality of copies of an article printed on a substrate;
wherein:
a first layer of a first copy of the article and a second layer of a second copy of the article extend in a projection plane and are printed simultaneously; and
the substrate is moved into a reservoir of resin at an angle relative to a surface of the resin during printing, wherein the angle is an acute angle.

29. The 3D printed article of claim 28, wherein the substrate is a pliable substrate.

30. The 3D printed article of claim 29, further comprising:
a second article printed on the substrate and disposed adjacent to the first copy of the article, wherein a third layer of the second article extends in the projection plane and is printed simultaneously while the first layer of the first copy of the article and the second layer of the second copy of the article are being printed.

31. The 3D printed article of claim 30, wherein the second article is a support structure for at least the first copy of the article.

32. The 3D printed article of claim 28, wherein the plurality of copies of the article are printed by a method for continuous 3D printing of the plurality of copies of the article, the method comprising:
executing a print file having instructions for printing a first copy of the article or first portion thereof on or adjacent to a first segment of a substrate; and
subsequently executing the print file to print a second copy of the article or second portion thereof on or adjacent to a second segment of the substrate, wherein the second segment is adjacent to the first segment of the substrate.
